(19) United States
(12) Patent Application Publication
(10) Pub. No.: US 2015/0338945 A1
(43) Pub. Date: Nov. 26, 2015

(54) INFORMATION PROCESSING DEVICE AND INFORMATION UPDATING PROGRAM

(71) Applicant: UBIQUITOUS ENTERTAINMENT INC., Tokyo (JP)

(72) Inventors: Tetsuro Masuda, Tokyo (JP); Makoto Kondo, Tokyo (JP); Hidemi Tsuji, Tokyo (JP); Makoto Hamatsu, Tokyo (JP)

(73) Assignee: UBIQUITOUS ENTERTAINMENT INC., Tokyo (JP)

(21) Appl. No.: 14/758,901

(22) PCT Filed: Apr. 23, 2013
(86) PCT No.: PCT/JP2013/061817

§ 371 Date: Jul. 1, 2015

(30) Foreign Application Priority Data
Jan. 4, 2013 (JP) 2013-000269

(51) Int. Cl. G06F 3/041; G06F 3/0488

(52) U.S. Cl. CPC G06F 3/041; G06F 3/0488

(57) ABSTRACT

In this information processing device such as a smartphone or a tablet computer provided with a touchscreen, when a number, character, or the like is written by means of a predetermined input means such as a stylus pen at a region at which a number, character, or the like contained in a file is displayed or a region at which a number, character, or the like is displayed by an application program on the touchscreen, the written number, character, or the like is identified, and a process for updating information to the identified number, character, or the like is executed. As a result, it is possible to update information at a displayed region by means of an intuitive operation of overwriting displayed information. If the configuration is such that information is not updated by means of another input means aside from a stylus pen, it also becomes possible to automatically switch from a display mode to an editing mode by altering the input means. Moreover, the subject of updating may be the actual information of the number, character, or the like being displayed, or may be a setting value for the displayed information.

### TECHNICAL FIELD

The present invention relates to information processing devices such as a tablet type computer and a smart phone, and an information updating program to be used in an information update processing in these information processing devices.

### BACKGROUND ART

In recent years, a portable network terminal having an information processing function such as a tablet type computer, a smart phone or the like spreads rapidly. In many cases, a touch screen (a touch panel) having an input device and a display device integrated with each other is used for inputting/outputting information to/from these terminals. The input of information to the touch screen is carried out by an operation for touching the screen with a touch pen or a finger.

In the case in which an image is input in paint software or the like, a locus is exactly drawn on the touch screen with the touch pen or the finger. In the case in which text data is to be input, generally, a keyboard is displayed on the touch screen and a key of a corresponding character or the like is selected to perform an input operation. For this reason, in the case in which a numeral or character displayed on the touch screen in accordance with an application program, a numeral or character contained in a displayed file or the like is to be updated, it is necessary to carry out an operation for calling the keyboard by a predetermined operation and inputting information to be updated by selecting a key.

On the other hand, the technique for overwriting a note or the like to displayed information in presentation software or the like, for example, is disclosed as a method of directly writing a character or the like onto a touch screen without using a keyboard, thereby overwriting information to the information displayed on the touch screen (for example, see Patent Documents 1 and 2). Moreover, there is disclosed the technique for executing a processing such as copy or deletion over information displayed on the touch screen by drawing a predetermined graphic on a touch screen without overwriting information (for example, see Patent Document 3).

### PRIOR ART DOCUMENT

### Patent Document

Patent Document 1: Japanese Laid-Open Patent Publication No. 2001-312264

Patent Document 2: Japanese Laid-Open Patent Publication No. 2004-178550

Patent Document 3: Japanese Laid-Open Patent Publication No. 2010-182023

### SUMMARY OF THE INVENTION

### Problem to be Solved

In the case in which a numeral or character displayed on the touch screen in accordance with an application program, a numeral or character contained in a displayed file or the like is to be updated, characters written on a screen and the like are simply displayed in overlap and the displayed character or numeral itself cannot be updated even if the techniques disclosed in the Patent Documents 1 and 2 are applied. Even if the technique disclosed in the Patent Document 3 is applied, moreover, a processing for deleting the displayed information is simply executed and the displayed character or numeral or the like is not updated to new information.

The present invention has been made to deal with the problem and has an object to provide an information updating program, an information updating method and an information processing device which can update a numeral displayed in accordance with an application program, a character or numeral contained in a displayed file or the like by an intuitive operation in an information processing device such as a tablet type computer or a smart phone.

### Means for Solving the Problem

The present invention for solving the problem is directed to an information processing device having a touch screen, including input detecting means for detecting an input operation by predetermined input means on a touch screen having information displayed thereon, information specifying means for specifying first information related to a region on the touch screen where the input operation is detected, information identifying means for identifying second information input by the input operation, and information updating means for updating the first information to the second information.

According to the present invention, when a numeral, a character or the like is written by predetermined input means such as touch pen to a region where a numeral, a character or the like is displayed on the touch screen in accordance with an application program or a region where a numeral, a character or the like contained in a file is displayed, the written numeral, character or the like is identified and a processing for updating information to the identified numeral, character or the like is executed. Therefore, it is possible to update the information in the displayed region by an intuitive operation for overwriting the displayed information.

Moreover, the present invention can also be characterized in that a touch screen capable of inputting information by first input means and second input means that can identify which input means executes the input operation is used for the touch screen, there is provided input identifying means for identifying whether the input means executing the input operation to the touch screen is the first input means or the second input means, and the input detecting means detects, as an input operation through the predetermined input means, the input operation identified by the input identifying means as the input operation executed by the first input means, and does not detect the input operation as the input operation through the predetermined input means even if the input operation is executed by the second input means. Furthermore, the present invention may be characterized in that the first input means is a touch pen for a touch screen and the second input means is a finger of an operator of the information updating device.

By such a structure, for example, the displayed information is not updated even if the operation is carried out by the second input means such as the finger in a state in which an application program such as paint software is started. When the input operation is carried out by the first input means such as the touch pen, however, the displayed information is updated. Even if an operation for switching the application program from a display mode to an edit mode is not carried out, therefore, it is possible to update information displayed in the display mode by only changing the input means from the finger to the touch pen to switch into the same state as the edit mode.

In many cases, the operation for updating the displayed information requires a finer input operation as compared with other operations such as startup of the application program or the like or page scroll, for example, an operation for inputting a shape of a character or a numeral by handwriting. For this reason, it is preferable that the touch pen capable of inputting a fine shape more easily than the finger should be used for the first input means.

Moreover, the present invention can also be characterized in that if two or more information are identified as candidates for the second information in the information identifying means, information having an information type matched with the first information in the candidates for the second information is identified as the second information.

In the present invention, for example, in some cases in which a vertical straight line is drawn with the touch pen, it is possible to recognize the line as a numeral “1” or to recognize the line as an alphabet “I”. There is employed a structure in which information having the same type (for example, a type of a numeral, an alphabet, kana, a sign or the like) as the first information to be an update target is selected from the candidates if two or more candidates are present in the second information identified by the input operation with the touch pen or the like. Consequently, it is possible to increase a probability that proper information can be identified.

Furthermore, the present invention can also be characterized in that the first information is information displayed in a region on the touch screen or a value set to the information displayed in the region on the touch screen.

Assuming that the first information is the former, for example, it is possible to update a numeral, a character or the like displayed on the touch screen in accordance with the application program or a numeral, a character or the like contained in the displayed file to a numeral, a character or the like input to the displayed region. Assuming that the first information is the latter, for example, it is possible to update a set value such as a page number set to information, for example, a thumbnail of a document file displayed on the touch screen to a numeral, a character or the like input to the displayed region.

The present invention can also be specified as an information updating program to be operated in the information processing device according to the present invention.

The present invention provides an information updating program for causing an information processing device including a touch screen to execute an input detecting step of detecting an input operation by predetermined input means on a touch screen having information displayed thereon, an information specifying step of specifying first information related to a region on the touch screen where the input operation is detected, an information identifying step of identifying second information input by the input operation, and an information updating step of updating the first information to the third information.

Moreover, the information updating program according to the present invention can also be characterized in that a touch screen capable of inputting information by first input means and second input means that can identify which input means executes the input operation is used for the touch screen, the information processing device is caused to execute an input identifying step of identifying whether the input means executing the input operation to the touch screen is the first input means or the second input means, and the input detecting step detects, as an input operation through the predetermined input means, the input operation identified by the input identifying means as the input operation executed by the first input means, and does not detect the input operation executed by the second input means as the input operation through the predetermined input means if any. The present invention may be characterize in that the first input means is a touch pen for a touch screen and the second input means is a finger of an operator of the information updating device.

Furthermore, the information updating program according to the present invention can also be characterized in that if two or more information are identified as candidates for the second information at the information identifying step, information having an information type matched with the first information is identified as the second information in the candidates for the second information.

Moreover, the information updating program according to the present invention can also be characterized in that the first information is information displayed in a region on the touch screen or a value set to the information displayed in the region on the touch screen.

### Effect of the Invention

According to the present invention, in an information processing device such as a tablet type computer or a smart phone which inputs information through a touch screen, it is possible to execute an information update processing over information displayed on the touch screen by such an intuitive operation as to overwrite new information. Thus, it is possible to expect enhancement in operability of the information processing device including the touch screen.

### BRIEF DESCRIPTION OF THE DRAWINGS

FIG. 1 is a block diagram showing a structure of an information processing device according to the present invention.

FIG. 2 is a first view showing a display example on a touch screen according to a first embodiment of the present invention.

FIG. 3 is a second view showing the display example on the touch screen according to the first embodiment of the present invention.

FIG. 4 is a third view showing the display example on the touch screen according to the first embodiment of the present invention.

FIG. 5 is a first view showing a display example on a touch screen according to a second embodiment of the present invention.

FIG. 6 is a second view showing the display example on the touch screen according to the second embodiment of the present invention.

FIG. 7 is a third view showing the display example on the touch screen according to the second embodiment of the present invention.

FIG. 8 is a flowchart showing a processing flow of an information updating program according to the present invention.

### MODE FOR CARRYING OUT THE INVENTION

A mode for carrying out the present invention will be described below in detail with reference to the drawings. The following description is only illustrative as the embodiments of the present invention and the present invention is not restricted to the embodiments.

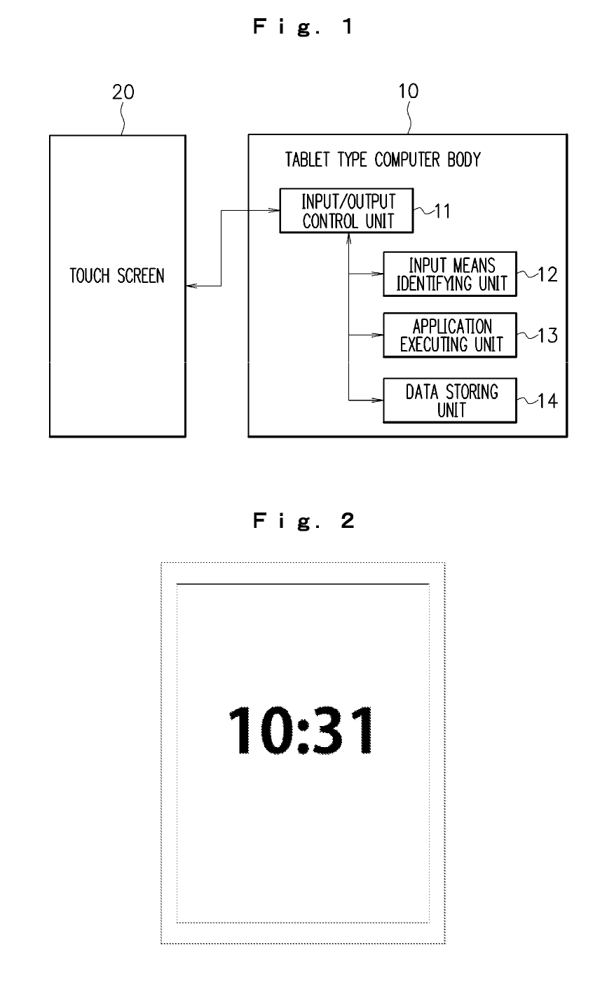

FIG. 1 shows an example of a structure of an information processing device according to the present invention. In the present invention, there is used an information processing device having an input/output function through a touch screen, for example, a tablet type computer, a smart phone or the like.

Input/output using the touch screen 20 can be carried out. Information may be input/output to/from a tablet type computer body 10 by a unit including means to be used in execution of other input/output functions such as voice input or output to an external device in addition to a touch screen 20. An operation result obtained by the tablet type computer body 10 is displayed on the touch screen 20, and furthermore, a touch pen or a finger touches the screen or a character or a graphic is drawn to input information.

The tablet type computer body 10 is a computer including an auxiliary storage for a CPU, a main memory, an HDD or the like. All of an input/output control unit 11, an input means identifying unit 12 and an application executing unit 13 provided in the tablet type computer body 10 are functionally specified, and a program corresponding to each function is read from the auxiliary storage to the main memory and an arithmetic processing is executed by the CPU so that a predetermined function is implemented. A predetermined storage area of the auxiliary storage in the tablet type computer body 10 is assigned to a data storing unit 14.

The input/output control unit 11 executes a processing related to input/output of information to/from the touch screen 20. More specifically, there is executed a processing for accepting an operation for detecting contact of a touch pen or a finger with the touch screen 20 and pressing down a button displayed on the touch screen, identifying a character or a graphic drawn with the touch pen or the finger or outputting the identified character or graphic to the touch screen 20. Although a program corresponding to the input/output control unit 11 is mainly included in an operating system (OS) of the tablet type computer body 10, it may be operated as middleware for causing the OS and an application program to cooperate with each other in addition to the OS.

The input means identifying unit 12 executes a processing for identifying first input means such as a touch pen coming in contact with the touch screen 20 and second input means such as a finger. In the present invention, it is required that information can be input from the touch screen by both the first input means such as the touch pen and the second input means such as the finger, and furthermore, which input means carried out the input can be identified. However, no particular limitation is given to which method can enable the input of both of the input means (for example, it is also possible to use a touch screen obtained by combining an electromagnetic induction system corresponding to the input through the touch pen and an electrostatic capacitance system corresponding to the input through the finger or to employ an analog resistive film system capable of carrying out the input by both of them) or to which system identifies both of them (for example, it is possible to identify both of them depending on a range in which contact is detected and to identify both of them depending on which system detected the input when using a touch screen obtained by combining the electromagnetic induction system and the electrostatic capacitance system corresponding to the input through the finger).

Various application programs including a clock application, document creating software, image management software and the like correspond to the application executing unit 13. The information updating program according to the present invention serves to execute a processing for updating information such as set values of these application programs corresponding to the application executing unit 13, or a numeral, a character or the like included in a file to be opened in accordance with the application program, and is executed as a part of functions of the input/output control unit 11 or a part of functions of the respective application programs to be operated by the application executing unit 13.

The data storing unit 14 stores data such as a file created in accordance with the application program and data such as a value set to the tablet type computer body 10, for example, a time set in a clock function or the like.

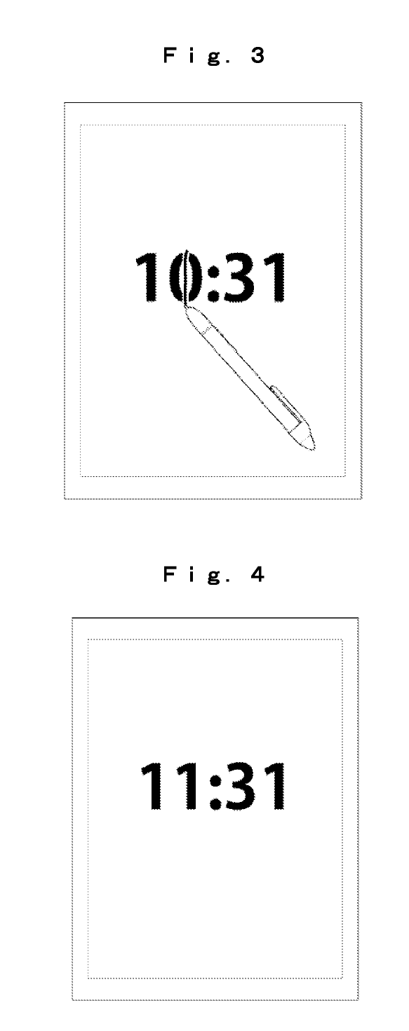

On the assumption of the structure described above, explanation will be given to a first embodiment of the present invention by using a display example on the touch screen 20 shown in FIGS. 2 to 4.

First of all, a user operates the touch screen 20 to start an application program displaying a clock in the tablet type computer body 10 by the application executing unit 13. Consequently, a screen displaying a time is output as shown in FIG. 2.

Next, an input operation for overwriting a numeral for updating a time (herein “10 o'clock” is updated to “11 o'clock”) as shown in FIG. 3 by using input means such as a touch pen in a region on the touch screen where the time is displayed.

In the tablet type computer body 10 detecting the operation in the input/output control unit 11, the input means identifying unit 12 identifies that the input means is a touch pen. The present invention suitably has the following structure. More specifically, information displayed on the touch screen 20 is updated in a procedure which will be described below as long as information is input by specific input means (in this example, the touch pen). Even if information is input by the other input means (for example, a finger), the information displayed on the touch screen 20 is not updated. The other input means (for example, the finger) is used for an operation such as startup of an application program (in this example, an application program for displaying a clock), movement of a display position, page scroll or the like. Even if an operation for switching the application program (in this example, the application program for displaying a clock) from a display mode to an edit mode is not carried out, consequently, switching into the same state as the edit mode is carried out by only changing the input means from the finger to the touch pen. Thus, it is possible to update the displayed information.

When the input means identifying unit 12 identifies that the input means is the touch pen, the tablet type computer body 10 recognizes a region where new information is input with the touch pen, identifies which value is possessed by the input new information (the value is identified as “1” in this example) if an updatable numeral or the like is displayed in that region (a “time” to be an updatable numeral is displayed in this example), updates the displayed value to the input value (herein “10 o'clock” is updated to “11 o'clock”) and stores the updated value in the main memory or the data storing unit 14 of the tablet type computer body 10, and furthermore, outputs the updated value and displays the updated value on the touch screen as shown in FIG. 4.

The means for inputting information to the touch screen is not restricted to the touch pen but may be the other input means such as the finger. In order to enable the switching from the display mode to the update mode depending on the input means as described above, however, it is preferable to use different input means in the update of the information and a normal operation. Furthermore, an operation in the update of the information often requires finer input operations as compared with other operations, for example, startup of an application program, page scroll and the like, that is, a shape of a character or a numeral is to be input by handwriting. Therefore, it is suitable to have a structure in which the touch pen is used for the input means (the first input means) in the update of the information and the finger is used for the input means (the second input means) in the normal operation.

Moreover, the value to be updated by input with the touch pen is not restricted to a numeral but a character, a sign, a graphic or the like may be updated.

Moreover, a region where new information is input and a region where an updatable value is displayed on the touch screen do not necessarily require perfect matching but may be intended for the case in which a part overlaps, the case in which new information is input to a predefined region with respect to the updatable value without any overlap, or the like.

In the update of the information displayed on the touch screen 20, presence of a plurality of candidates such as numerals or characters becomes a problem in some cases in which the information input with the touch pen is identified. In the example shown in FIG. 3, “1” is overwritten to a region where “0” is displayed. In some cases, however, a shape input as the numeral “1” can be identified as a character “I”. In these cases, it is necessary to determine which information is to be selected from the identified candidates and to be thus used for update.

In these cases, a type of the information of “0” to be an update target is a numeral. If the numeral “1” having an information type matched is selected, therefore, there is increased a probability that the information might be properly updated. For this reason, when the input is accepted by the touch screen 20 and two or more information are identified as the candidates for information to be updated, it is sufficient to identify, as information to be updated, information having an information type matched with the information to be the update target in these candidates.

Although the type of the information to be updated is specified as a matter of course when the input shape is identified as a numeral or a character by a general character recognition technique, a method of specifying the type of the information to be the update target is not particularly restricted. In the examples shown in FIGS. 2 to 4, the application program for displaying the clock is started. Therefore, the information displayed in the region for displaying a time can be specified as a numeral. In the case in which a shape drawn in paint software or the like is a target, it is sufficient to specify the type of the information such as the numeral or the character by the general character recognition technique.

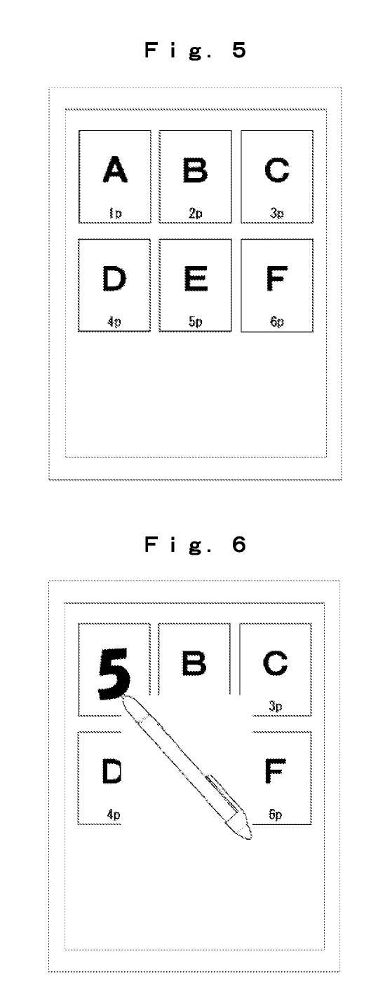

Next, a second embodiment according to the present invention will be described by using a display example on the touch screen 20 shown in FIGS. 5 to 8.

First of all, it is assumed that a user operates the touch screen 20 to start document creating software by the application executing unit 13 in the tablet type computer body 10, thereby opening a created document file and displaying a thumbnail for each page on the screen as shown in FIG. 5.

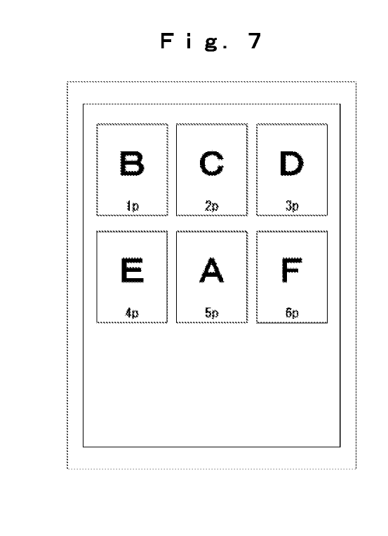

Subsequently, an operation for inputting a numeral (herein “page 1” is updated to “page 5”) to update a page number is carried out as shown in FIG. 6 by using the input means such as the touch pen in a region on the touch screen where a single thumbnail (herein a thumbnail on page 1) is displayed.

In the tablet type computer body 10 detecting the operation in the input/output control unit 11, the input means identifying unit 12 identifies the input means as the touch pen. Also in the second embodiment, it is suitable to have a structure in which the information displayed on the touch screen 20 is updated in a procedure which will be described below only when the information is input by specific input means (the touch pen in this example), and the information displayed on the touch screen 20 is not updated even if the information is input by the other input means (for example, the finger) in the same manner as in the first embodiment.

When the input means identifying unit 12 identifies the input means as the touch pen, the tablet type computer body 10 recognizes a region where new information is input with the touch pen or the like, identifies which value is possessed by the input new information (the information is identified as “5” in this example) if information including an updatable element such as a set value is displayed in the region (herein “page number” to be a thumbnail capable of updating a set value is displayed), updates the set value of the information present in the display region to the input value (herein “page 1” is updated to “page 5”) and stores the updated value in the main memory or the data storing unit 14 of the tablet type computer body 10, and furthermore, outputs a screen having a display form changed corresponding to the updated set value (herein a screen having page order changed) and displays the changed display form on the touch screen 20 as shown in FIG. 7.

Set values of other information required with the update of the set value of the information present in the displayed region are updated together (herein “page 2” is updated to “page 1”, for example) and the updated values are stored in the main memory or the data storing unit 14 of the tablet type computer body 10.

The means for inputting the information to the touch screen is not restricted to the touch pen but the other input means such as the finger may be applied. In the same manner as in the first embodiment, however, it is suitable to have a structure in which different input means are used in update of information and a normal operation, particularly, the touch pen is used for the input means (the first input means) in the update of the information and the finger is used for the input means (the second input means) in the normal operation, a region where new information is input and a region where information having an updatable set value is displayed on the touch screen do not necessarily require perfect matching but may be intended for the case in which a part overlaps, the case in which new information is input to a predefined region with respect to the updatable information without any overlap, or the like, and it is sufficient to identify, as information to be updated, the information having an information type matched with the information to be the update target when two or more information are identified as candidates for the information to be updated.

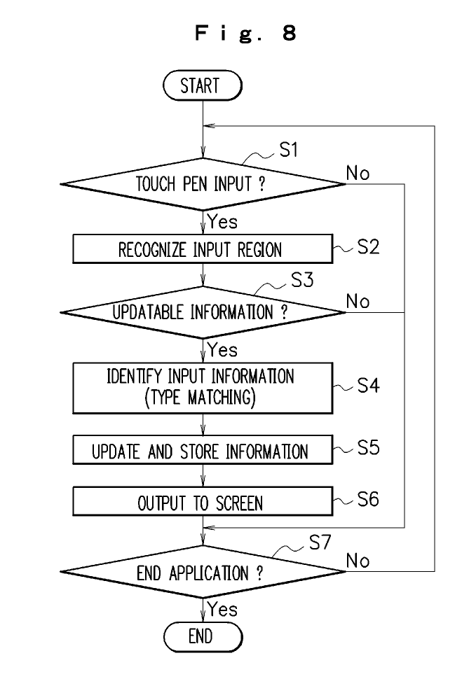

FIG. 8 shows, as a flowchart, a processing flow based on the information updating program according to the present invention described above.

The information updating program according to the present invention is started by triggering startup of a predetermined application program or a transition to an edit mode in the application program. First of all, if it is detected that an input operation is carried out with the touch pen in the touch screen (S1), a region where information is input is recognized (S2). In the case in which the input operation is carried out by input means other than the touch pen, a processing which will be described below is not executed. Presence of next input is monitored (S1) until the application program triggered for startup or the edit mode of the application program is ended (S7).

When the region where the information is input is recognized, it is confirmed whether information itself such as a numeral or a character or information including an updatable element, for example, a set value of the displayed information or the like is displayed in the recognized region (S3). If the information including the updatable element is not displayed, the presence of next input is monitored (S1) until the application program triggered for startup or the edit mode of the application program is ended (S7).

If the information including the updatable element is displayed, it is identified which numeral, character or the like is possessed by the input information (S4). The displayed information itself such as a numeral or a character or the set value of the displayed information is updated and stored in the main memory or the auxiliary storage of the information processing device (S5), and a processing for reflecting the updated information and outputting the information to the touch screen is executed (S6). If numerals, characters or the like are identified as candidates in the S4, information having an information type matched with an update target is selected as information to be updated. When these processings are ended, the presence of next input is monitored (S1) until the application program triggered for the startup or the edit mode of the application program is ended (S7).

### EXPLANATION OF DESIGNATION

10 tablet type computer body

11 input/output control unit

12 input means identifying unit

13 application executing unit

14 data storing unit

20 touch screen

1. An information processing device including a touch screen, comprising:
input detecting means for detecting an input operation by predetermined input means on a touch screen having information displayed thereon;
information specifying means for specifying first information related to a region on the touch screen where the input operation is detected;
information identifying means for identifying second information input by the input operation; and
information updating means for updating the first information to the second information.

2. The information processing device according to claim 1, wherein a touch screen capable of inputting information by first input means and second input means that can identify which input means executes the input operation is used for the touch screen,
there is provided input identifying means for identifying whether the input means executing the input operation to the touch screen is the first input means or the second input means, and
the input detecting means detects, as an input operation through the predetermined input means, the input operation identified by the input identifying means as the input operation executed by the first input means, and does not detect the input operation as the input operation through the predetermined input means even if the input operation is executed by the second input means.

3. The information processing device according to claim 2, wherein the first input means is a touch pen for a touch screen and the second input means is a finger of an operator of the information updating device.

4. The information processing device according to claim 1, wherein if two or more information are identified as candidates for the second information in the information identifying means, information having an information type matched with the first information in the candidates for the second information is identified as the second information.

5. The information processing device according to claim 1, wherein the first information is information displayed in a region on the touch screen or a value set to the information displayed in the region on the touch screen.

6. An information updating program for causing an information processing device including a touch screen to execute:
an input detecting step of detecting an input operation by predetermined input means on a touch screen having information displayed thereon;
an information specifying step of specifying first information related to a region on the touch screen where the input operation is detected;
an information identifying step of identifying second information input by the input operation; and
an information updating step of updating the first information to the third information.

7. The information updating program according to claim 6, wherein a touch screen capable of inputting information by first input means and second input means that can identify which input means executes the input operation is used for the touch screen,
the information processing device is caused to execute an input identifying step of identifying whether the input means executing the input operation to the touch screen is the first input means or the second input means, and
the input detecting step detects, as an input operation through the predetermined input means, the input operation identified by the input identifying means as the input operation executed by the first input means, and does not detect the input operation executed by the second input means as the input operation through the predetermined input means if any.

8. The information updating program according to claim 7, wherein the first input means is a touch pen for a touch screen and the second input means is a finger of an operator of the information updating device.

9. The information updating program according to claim 6, wherein if two or more information are identified as candidates for the second information at the information identifying step, information having an information type matched with the first information is identified as the second information in the candidates for the second information.

10. The information updating program according to claim 6, wherein the first information is information displayed in a region on the touch screen or a value set to the information displayed in the region on the touch screen.

11. The information processing device according to claim 2, wherein if two or more information are identified as candidates for the second information in the information identifying means, information having an information type matched with the first information in the candidates for the second information is identified as the second information.

12. The information processing device according to claim 3, wherein if two or more information are identified as candidates for the second information in the information identifying means, information having an information type matched with the first information in the candidates for the second information is identified as the second information.

13. The information processing device according to claim 2, wherein the first information is information displayed in a region on the touch screen or a value set to the information displayed in the region on the touch screen.

14. The information processing device according to claim 3, wherein the first information is information displayed in a region on the touch screen or a value set to the information displayed in the region on the touch screen.

15. The information processing device according to claim 4, wherein the first information is information displayed in a region on the touch screen or a value set to the information displayed in the region on the touch screen.

16. The information updating program according to claim 7, wherein if two or more information are identified as candidates for the second information at the information identifying step, information having an information type matched with the first information is identified as the second information in the candidates for the second information.

17. The information updating program according to claim 8, wherein if two or more information are identified as candidates for the second information at the information identifying step, information having an information type matched with the first information is identified as the second information in the candidates for the second information.

18. The information updating program according to claim 7, wherein the first information is information displayed in a region on the touch screen or a value set to the information displayed in the region on the touch screen.

19. The information updating program according to claim 8, wherein the first information is information displayed in a region on the touch screen or a value set to the information displayed in the region on the touch screen.

20. The information updating program according to claim 9, wherein the first information is information displayed in a region on the touch screen or a value set to the information displayed in the region on the touch screen.
